(19) United States
(12) Patent Application Publication
(10) Pub. No.: US 2010/0040831 A1
(43) Pub. Date: Feb. 18, 2010

(54) ARRAY STRUCTURE OF NANO MATERIALS

(75) Inventor: Youngtack Shim, Seoul (KR)

Correspondence Address: KNOBBE MARTENS OLSON & BEAR LLP, 2040 MAIN STREET, FOURTEENTH FLOOR, IRVINE, CA, 92614, US

(73) Assignee: SEOUL NATIONAL UNIVERSITY RESEARCH & DEVELOPMENT BUSINESS FOUNDATION (SNU R&DB FOUNDATION), Seoul (KR)

(21) Appl. No.: 12/192,017

(22) Filed: Aug. 14, 2008

(51) Int. Cl. B32B 5/02; B44C 1/22

(52) U.S. Cl. 428/141; 216/18

(57) ABSTRACT

There is provided a novel array structure of nano materials. The array structure may comprise a first set of conductive electrodes, a second set of conductive electrodes and a plurality of first nano material strands protruding from the first conductive electrodes. The first nano material strands may be arranged in a coplanar relationship on a first plane. The array structure may further comprise a plurality of second nano material strands protruding from the second conductive electrodes. The second nano material strands may be arranged in a coplanar relationship on a second plane, which is substantially parallel with the first plane. At least a part of the second nano material strands may extend in a transverse relationship with respect to at least a part of the first nano material strands.

### TECHNICAL FIELD

The present disclosure relates generally to an array structure of nano materials.

### BACKGROUND

One of the principal themes in the field of nanotechnology is the development of nano materials on an atomic or molecular scale (i.e., smaller than a micron). New or preeminent properties of the nano materials are attributed to their nanoscale size. Compared to macroscale materials, the materials reduced to nanoscale display very different properties, which enable them to be adapted for various applications. For example, an opaque substance of macroscale may become a transparent substance of nanoscale, a stable substance of macroscale may turn into a combustible substance of nanoscale, a solid substance of macroscale may be converted into a liquid substance of nanoscale at room temperature, and an insulator of macroscale may become a conductor of nanoscale. Due to such novel properties, the nano materials have been widely applied in various fields.

However, despite their superior mechanical, chemical and electrical properties, there have been certain drawbacks in using the nano materials due to the difficulty of handling such small materials in making a useful structure. In order to fully utilize and apply the preeminent properties of the nano materials in various fields, it is necessary to conceive various reliable nano material cluster structures and suitable arrangement mechanisms for positioning the same in a desired arrangement.

### SUMMARY

The present disclosure provides a novel and innovative array structure of nano materials. The array structure may comprise a first set of conductive electrodes, a second set of conductive electrodes and a plurality of first nano material strands protruding from the first conductive electrodes. The first nano material strands may be arranged in a coplanar relationship on a first plane. The array structure may further comprise a plurality of second nano material strands protruding from the second conductive electrodes. The second nano material strands may be arranged in a coplanar relationship on a second plane, which is substantially parallel with the first plane. At least a portion of the second nano material strands may extend in a parallel, perpendicular or transverse relationship with respect to at least a portion of the first nano material strands.

In one embodiment, the first conductive electrodes may be equally spaced apart from each other. Alternatively, however, some or all of the first electrodes may be unevenly spaced apart from each other.

In another embodiment, the second conductive electrodes may be equally spaced apart from each other. Alternatively, however, some or all of the second electrodes may be unevenly spaced apart from each other.

In yet another embodiment, the first electrodes may be equally spaced apart from the second electrodes. Alternatively, however, some or all of the first electrodes may be unevenly spaced apart from the second electrodes.

In yet another embodiment, the first and/or second conductive electrodes may generally have the shape of a square pillar or cylinder.

In yet another embodiment, the first and second electrodes may have the same shape. Alternatively, however, at least some of the first and second electrodes may have different shapes.

In yet another embodiment, the second conductive electrodes may be taller than the first conductive electrodes. Alternatively, however, the second conductive electrodes may be shorter than the first conductive electrodes.

In yet another embodiment, the first and second nano material strands may include carbon nanotubes, carbon nanowires or other elongated nano materials.

In yet another embodiment, the first and second conductive electrodes may be arranged so as to form the shape L. Further, one of the second conductive electrodes may be located at the corner of the shape L.

In yet another embodiment, the first nano material strands protruding from the first conductive electrode placed at the corner of the shape L may extend in a transverse relationship with respect to the second conductive electrodes.

The present disclosure provides another array structure of nano materials. The array structure may comprise a substrate, a first set of conductive electrodes disposed on the substrate, a second set of conductive electrodes disposed on the substrate, and a plurality of first and second nano material strands. The first nano material strands may protrude from the first conductive electrodes along at least a substantially similar first direction and in a first elevation. Further, the second nano material strands may protrude from the second conductive electrodes along at least a substantially similar second direction and in a second elevation from the substrate. The second elevation may differ from the first elevation by at most several hundreds of nanometers. Accordingly, the first and second nano materials may interact with each other when disposed adjacent to a target.

The present disclosure provides yet another array structure of nano materials. The array structure may comprise a substrate, a first array of first nano material strands, a second array of second nano material strands, at least one conductive electrode, and at least one second conductive electrode. The first array of first nano material strands may extend in a first direction and be directly or indirectly supported by the substrate. The second array of second nano material strands may extend in a second direction and be directly or indirectly supported by the substrate. The first conductive electrode may electrically contact the first nano material strands and mechanically couple with the substrate. Further, the second conductive electrode may electrically contact the second nano material strands and mechanically couple with the substrate. In addition, the first and second strands may be disposed in a preset arrangement and spaced apart from each other by at most several hundreds of nanometers. By doing so, the first and second strands may interact with each other when disposed adjacent to a target.

In one embodiment, the first and second strands may be disposed in the same elevation with respect to the substrate.

In another embodiment, the first and second strands may be disposed in different elevations with respect to the substrate.

In yet another embodiment, at least some of the first and second strands may be disposed parallel, normal or transverse with respect to each other.

The present disclosure further provides a novel method of preparing an array structure of nano materials. Such a method may comprise the step of providing a first layered structure having multiple layers on a substrate. The first layered structure may include a layer having first nano material strands therein. The method of the present disclosure may also comprise the steps of patterning the first layered structure to define first multiple recesses such that end portions of the first nano material strands and a part of the substrate in registration with the end portions are exposed through said first multiple recesses, filling said first multiple recesses with a conductive material to provide an intermediate structure, and providing a second layered structure having multiple layers on the intermediate structure. The second layered structure may include a layer having second nano material strands therein. The above method may further comprise the steps of patterning the second layered structure to define second multiple recesses such that end portions of the second nano material strands and a part of the substrate in registration with the end portions are exposed through said second multiple recesses, and filling said second multiple recesses with a conductive material.

In one embodiment, the substrate may include transparent materials.

In another embodiment, the first nano material strands may be arranged in parallel and substantially equally spaced apart from each other.

In yet another embodiment, the second nano material strands may be arranged in parallel and substantially equally spaced apart from each other.

In yet another embodiment, the first and second nano material strands may include carbon nanotubes or carbon nanowires.

In yet another embodiment, the second nano material strands may be arranged so as to be perpendicular to an extending direction of the first nano material strands.

In yet another embodiment, the method may further comprise the step of trimming the first nano material strands so that such strands have a substantially equal length.

In yet another embodiment, the method may further comprise the step of trimming the second nano material strands so that such strands have a substantially equal length.

In yet another embodiment, the first multiple recesses may generally have the shape of a square pillar or cylinder.

In yet another embodiment, the second multiple recesses may generally have the shape of a square pillar or cylinder.

In yet another embodiment, the first multiple recesses and the second multiple recesses may be arranged so as to form the shape L. Further, one of the second recesses may be located at the corner of the shape L.

In yet another embodiment, one of the second nano material strands may be arranged to extend in a transverse relationship with the first recesses. The remaining second nano material strands may be arranged to extend in a transverse relationship with at least a part of the first nano material strands.

In yet another embodiment, the step of providing the first layered structure may comprise the steps of depositing a first photoresist layer on the substrate, patterning the first photoresist layer to define first multiple grooves, filling the first multiple grooves with nano materials so that the first nano material strands match the respective grooves, and depositing a second photoresist layer to cover the first photoresist layer having the first nano material strands therein.

In yet another embodiment, the step of providing the second layered structure may comprise the steps of depositing a third photoresist layer on the intermediate structure, patterning the third photoresist layer to define second multiple grooves, filling the second grooves with nano materials so that the second nano material strands match the respective grooves, and depositing a fourth photoresist layer to cover the third photoresist layer having the second nano material strands therein.

In yet another embodiment, the method of the present disclosure may further comprise the step of removing the first, second, third and fourth photoresist layers after filling the second multiple recesses with the conductive material.

In yet another embodiment, the thickness of the first nano material strands may be less than the depth of the first multiple grooves.

In yet another embodiment, the thickness of the second nano material strands may be less than the depth of the second multiple grooves

This Summary is provided to introduce a selection of concepts in a simplified form that are further described below in the Detailed Description. The Summary is not intended to identify key or essential features of the claimed subject matter, nor is it intended to be used to limit the scope of the claimed subject matter.

### BRIEF DESCRIPTION OF THE DRAWINGS

FIGS. 1A to 1C show schematic diagrams of an array structure of nano materials in accordance with one embodiment; and

FIGS. 2 to 14 collectively show a process of preparing an array structure of nano materials in accordance with one embodiment.

### DETAILED DESCRIPTION

In the following detailed description, reference is made to the accompanying drawings, which form a part hereof In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the components of the present disclosure, as generally described herein, and illustrated in the Figures, may be arranged, substituted, combined, and designed in a wide variety of different configurations, all of which are explicitly contemplated and make part of this disclosure.

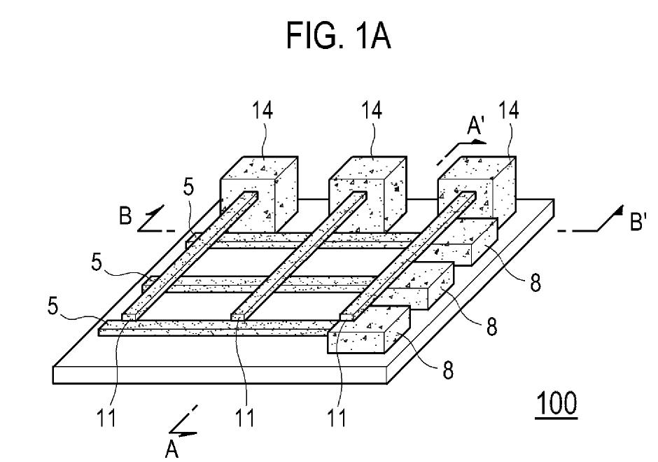

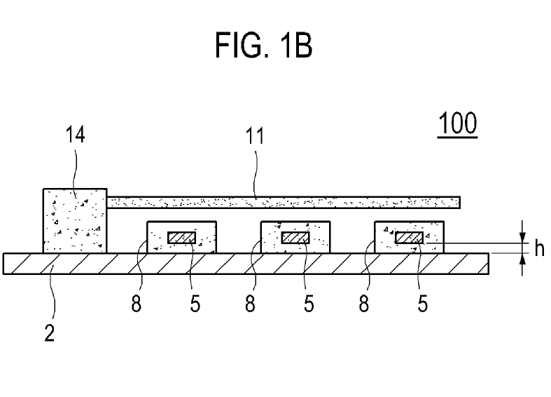

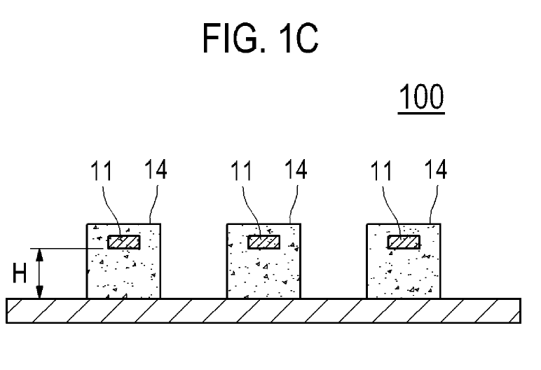

FIGS. 1A to 1C show schematic diagrams of an array structure of nano materials 100 in accordance with one embodiment. It should be appreciated that the structure may include arrays of nano materials in different elevations, wherein such arrays may extend parallel to each other, cross each other or overlap each other at a preset angle. For simplicity of illustration, the following figures exemplify the structures wherein the arrays cross each other. It should be understood, however, that each and every embodiment disclosed hereinafter may also apply to the structures wherein the arrays are parallel or transverse to each other.

Specifically, FIG. 1A shows an oblique view of the array structure of nano materials 100 from an upper right side position. Further, FIGS. 1B and 1C show longitudinal and lateral cross-sectional views of the array structure of nano materials 100 along lines A-A′ and B-B′, respectively.

As shown in FIG. 1A, the array structure of nano materials 100 may include a substrate 2. The substrate 2 may have any arbitrary shape. In this example, however, the substrate 2 has the shape of a thin plate including relatively large top and bottom opposing surfaces and two pairs of slim and long lateral surfaces. The substrate 2 may be formed from materials selected in consideration of features required for a specific application field. For example, a transparent glass, indium tin oxide or other types of transparent or translucent materials may be used to provide the substrate 2 for allowing the resulting structure to be used in a transparent device. In another example, an electrically conductive, semiconductive or insulative material may be employed in the substrate 2 to allow the resulting structure to be used for an electrical device. In another example, a ferromagnetic, paramagnetic or ferromagnetic material may be used to form the substrate 2 to allow the resulting structure to be used for a magnetic device.

The array structure of nano materials 100 may further include a first set of conductive electrodes 8. Each conductive electrode 8 may take the shape of a square pillar having top and bottom surfaces. In another embodiment, the conductive electrodes 8 may take the shape of a cylinder. The conductive electrodes 8 may be aligned along an edge 22 of the substrate 2. The longitudinal edges of the top and bottom surfaces of the conductive electrodes 8 may be substantially parallel to the edge 22 of the substrate 2. As shown in FIG. 1A, the conductive electrodes 8 may be equally spaced apart in the longitudinal direction. However, the present disclosure is not limited to such an arrangement. Each conductive electrode 8 may also have two pairs of lateral surfaces disposed between and in perpendicular to the top and bottom surfaces. The lateral surface 82 of each conductive electrode 8, which is distant from the edge 22, is referred to as an inward side surface 82 of the conductive electrode 8. The bottom surface of each conductive electrode 8 may be attached to the top surface of the substrate 2. The conductive electrodes 8 may be made from one or more electrically conductive materials such as, for example, but not limited to, Ag, Cu, Al, etc.

The array structure of nano materials 100 may further include a set of conductive electrodes 14. Each conductive electrode 14 may form the shape of a square pillar including a pair of top and bottom surfaces. In another embodiment, the conductive electrodes 14 may take the shape of a cylinder. The conductive electrodes 14 may be aligned with the same or another edge 24 of the substrate 2 (the provided figure shows the latter embodiment). The longitudinal edges of the top and bottom surfaces of the conductive electrodes 14 may be substantially parallel to the edge 24 of the substrate 2. As shown in FIG. 1A, the conductive electrodes 14 may be equally spaced apart from each other in the lateral direction. However, the present disclosure is not limited to such an arrangement. Each conductive electrode 14 may also have two pairs of lateral surfaces disposed between and in perpendicular to the top and bottom surfaces. The lateral surface 142 of each conductive electrode 14, which is distant from the edge 24, is referred to as an inward side surface 142 of the conductive electrode 14. The bottom surface of each conductive electrode 14 may be attached to the top surface of the substrate 2. The conductive electrodes 14 may be made from one or more electrically conductive materials such as, for example, but not limited to, Ag, Cu, Al, etc.

The array structure of nano materials 100 may further include a first set of nano material strands 5 protruding from the inward side surfaces 82 of the conductive electrodes 8. Each of the nano material strands 5 may have the shape of an elongated tube or rod. The first set of nano material strands 5 may form a coplanar relationship with each other and be substantially parallel to the substrate 2. The distance between the substrate 2 and the nano material strands 5 is represented by h. The nano material strands 5 may be substantially parallel to each other and be further substantially perpendicular to the conductive electrodes 8. The length of the laterally extending portion of the first nano material strands 5 may be relatively greater than its width or thickness. Although the illustrated embodiment shows the nano material strands 5 as being equally spaced apart, said strands 5 may also be unequally or irregularly spaced apart from each other. In one embodiment, the nano material strands 5 may include, for example, carbon nanotubes, carbon nanowires or other elongated nano materials.

The array structure of nano materials 100 may further include a second set of nano material strands 11 protruding from the inward side surfaces 142 of the conductive electrodes 14. Each of the nano material strands 11 may have the shape of a thin and fine tape. The nano material strands 11 may form a coplanar relationship and be substantially parallel to the substrate 2. As shown in FIG. 1A, the nano material strands 11 protruding from the inward side surfaces 142 of the conductive electrodes 14 may extend in a transverse relationship with the first set of conductive electrodes 8 or the nano material strands 5 protruding therefrom. The distance between the substrate 2 and the nano material strands 11 is represented by H (greater than h). The nano material strands 11 may be substantially parallel to each other and extend in the longitudinal direction perpendicular to the conductive electrodes 14. The length of the longitudinally extending portion of the second nano material strands 11 may be relatively greater than its width or thickness. Although the illustrated embodiment shows the nano material strands 11 as being equally spaced apart, said strands 11 may also be unequally or irregularly spaced apart from each other. In one embodiment, the nano material strands 11 may include, for example, carbon nanotubes or carbon nanowires.

As shown in FIG. 1A, the first and second sets of conductive electrodes 8, 14 may be respectively disposed along the edges 22, 24 of the substrate 2, which are perpendicular to each other to thereby form the shape “L.” Further, as shown in FIGS. 1A and 1B, the conductive electrodes 14 may be taller than the conductive electrodes 8. In this embodiment, one of the second conductive electrodes 14 may be located at the corner of the shape L. Thus, the nano material strand 11 protruding from the conductive electrode 14, which may be located at the corner of the shape L, may form and extend in a transverse relationship with the conductive electrodes 8 (not the nano material strands 5).

In this embodiment, the first set of conductive electrodes 8 may be perpendicular to the second set of conductive electrodes 14. Further, as described above, one of the second conductive electrodes 14 may be placed at the corner of the shape L. However, the present disclosure is not limited to such an arrangement. In another embodiment, the first and second sets of conductive electrodes may form an acute or obtuse angle therebetween. Further, in another embodiment, the conductive electrode may not be located at the corner of the shape L. The conductive electrodes 8 and the nano material strands 5 protruding therefrom may be electrically isolated and separately controlled from the conductive electrodes 14 and the nano material strands 11 protruding therefrom. As set forth herein, the first and second electrodes may be disposed in a parallel, perpendicular or transverse arrangement. Depending on the arrangement, the nano material strands protruding from the first and second electrodes may also be disposed in a parallel, perpendicular or transverse arrangement.

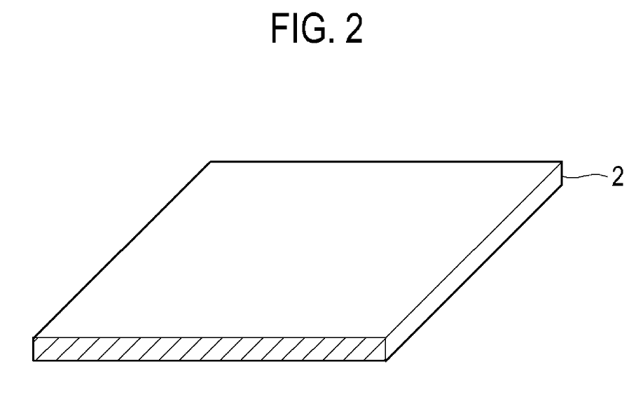

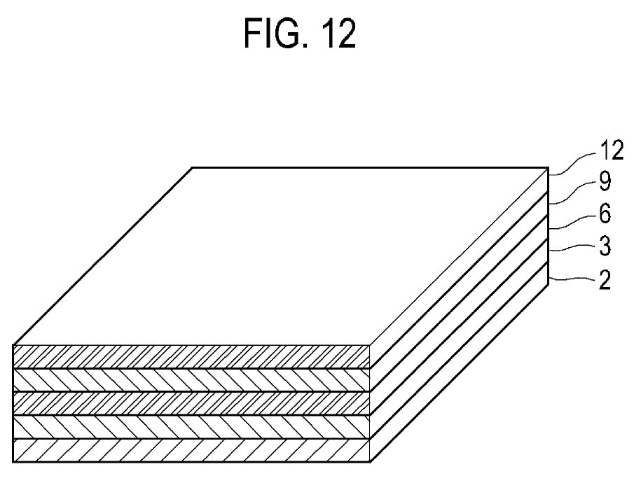

FIGS. 2 to 14 collectively show a process of preparing an array structure of nano materials in accordance with one embodiment.

As shown in FIG. 2, a substrate 2 may be provided. As described above, the substrate 2 may be selected in consideration of features required for a specific application field. For example, to allow the resulting structure to be used in an optical device, the substrate 2 may be transparent, translucent or opaque. In another embodiment, the substrate 2 may be electrically conductive, semi-conductive or insulative when the resulting structure is to be used as an electronic device. Similarly, the substrate 2 may be ferromagnetic, paramagnetic and the like when the resulting device is to be used in a magnetic device.

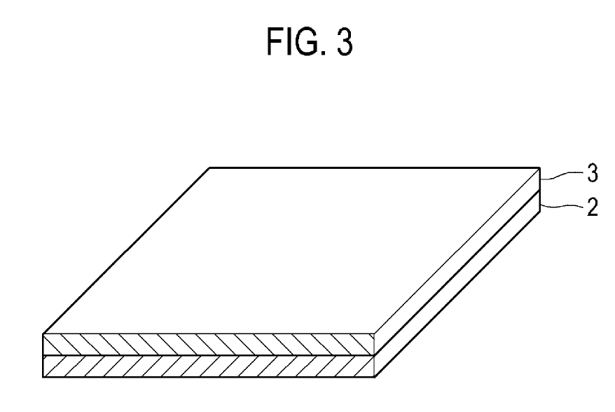

As shown in FIG. 3, a first photoresist layer 3 may be deposited on the substrate 2 to a preset thickness. The thickness of the photoresist layer 3 may be selected by those skilled in the art in consideration of the relationship between etching resistance and resolution. The first photoresist layer 3 may have a resolution sufficient enough to enable a subsequent nanoscale fine patterning. Further, the first photoresist layer 3 may be fabricated from one or more conventional photoresist materials.

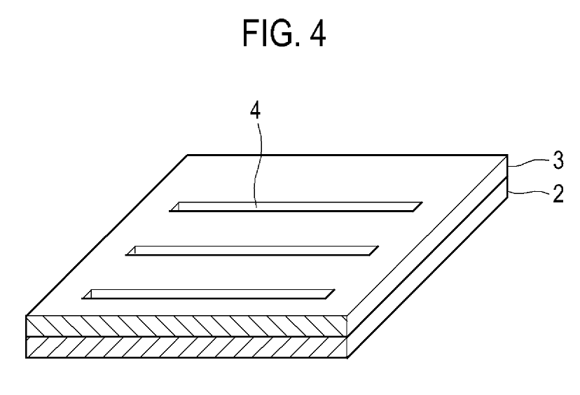

Referring to FIG. 4, the first photoresist layer 3 may be patterned by photolithography or other equivalent processes to define one or more grooves 4 thereon. The length of each groove 4 may be greater than its width in the longitudinal direction. As shown in FIG. 4, the grooves 4 may be arranged in parallel to each other. Further, the grooves 4 may be substantially equally spaced apart from each other. However, it should be noted that the present disclosure is not limited to such an arrangement. According to one embodiment, the grooves formed in the first photoresist layer 3 may have different lengths or widths. Further, according to one embodiment, the grooves formed in the first photoresist layer may be unequally or irregularly spaced apart from each other.

In one embodiment, the first photoresist layer 3 may be exposed to an ultraviolet light through a mask having a fine groove pattern image. The exposed photoresist layer 3 may then be developed to form the grooves 4 by using a chemical etchant, plasma gas or other equivalent materials. Alternatively, the photoresist layer 3 may be patterned by other similar processes such as using lasers, ion beams and the like.

The depth of the grooves 4 may be equal to or less than the thickness of the first photoresist layer 3. In one embodiment, the depth of the grooves 4 may be as shallow as possible. In case of using a chemical etching method, a selected etchant, selected etching time, etc. may control the depth of the grooves 4. The depth of the grooves 4 may also be controlled by varying an intensity of the lasers or ion beams, a period of exposure or other process variables associated therewith.

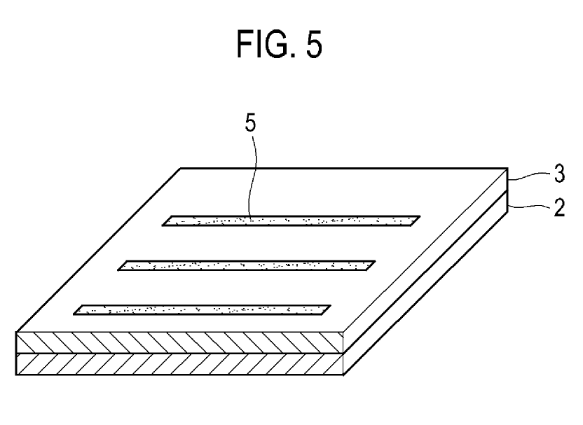

Thereafter, as shown in FIG. 5, a nano material may be deposited into the grooves 4 to define nano material strands 5 matching the respective grooves 4. The nano material strands 5 may include, for example, but are not limited to, carbon nanotubes, carbon nanowires, other elongated nano materials, quantum dots and the like.

In one embodiment, a suspension, an emulsion, a solution or liquid mixture of nano materials (hereinafter, collectively referred to as “the suspension of nano materials”) may be poured on top of the first photoresist layer 3. The suspension of nano materials may migrate into the grooves 4 by gravity, diffusion or other mechanical, electrical or magnetic forces, and define the shapes and sizes matching those of the grooves 4.

In one embodiment, a gas jet device may be used to eject a stream of gas so as to sweep the poured suspension of nano materials from the first photoresist layer 3. In such a case, a greater amount of nano materials may enter the grooves due to the pressure of the ejected gas stream. In one embodiment, after supplying the suspension of nano materials over the grooves to allow at least some of the nano materials to enter the grooves, a gas jet device may be applied on the suspension of nano materials to cause the nano-materials, which are disposed outside the groove, to further move into the grooves and be trapped therein. Alternatively, centrifugal force may be used to allow greater amounts of nano materials to be aligned with the grooves 4 and then enter the same. When diffusing the nano materials into the grooves on the substrate using the centrifugal force, the substrate may be placed in a substantially circular fluid channel, which is filled with a fluid medium containing the nano materials. The fluid medium may be caused to be rotated within the fluid channel, wherein the nano materials may then be diffused into the grooves on the substrate. Further, in another embodiment, when the nano materials respond to electric or magnetic fields, external electric or magnetic fields may allow such materials to be aligned with and attracted (or repelled) into the grooves 4.

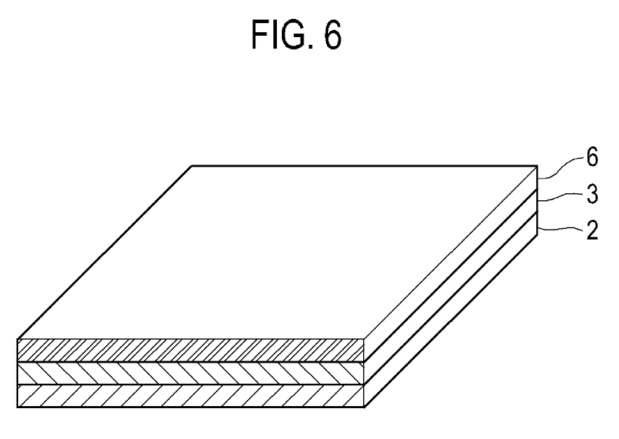

As shown in FIG. 6, a second photoresist layer 6 may be deposited onto the first photoresist layer 3 so as to entirely cover the grooves 4 having the nano material strands 5 disposed therein. It should be noted that the second photoresist layers 6 may be fabricated from the same materials as the first photoresist layer 3. Alternatively, the second photoresist layer 6 may be fabricated from different materials as long as it can be removed together with the first photoresist layer in one patterning stage. Since the process of depositing the second photoresist layer 6 is similar to the process of depositing the first photoresist layer 3, its detailed explanations are omitted herein.

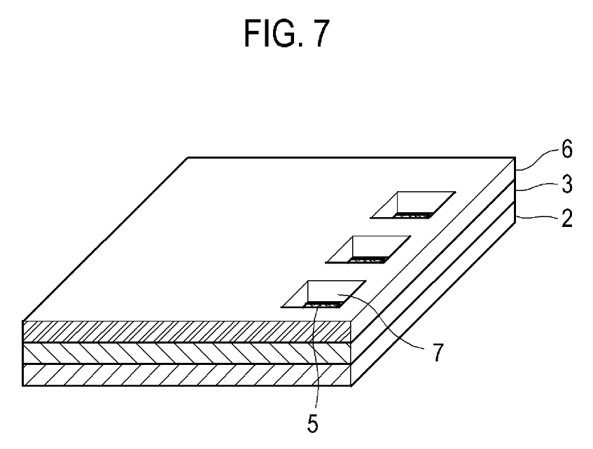

Thereafter, as shown in FIG. 7, the first and second photoresist layers 3, 6 may be patterned by photolithography or other equivalent processes to define the same number of recesses 7 as the grooves 4 passing through the first and second photoresist layers 3, 6. The recesses 7 may be aligned with the edge 22 of the substrate 2. Moreover, the recesses 7 may be equally spaced apart from each other, although they are not limited to such an arrangement. Further, photolithography or other equivalent processes may be performed so as to remove a desired portion of the first photoresist layer 3 disposed under the second photoresist layer 6 to a preset depth. In one embodiment, the first and second photoresist layers 3, 6 may be patterned away to expose the substrate 2 through the recesses 7. The first and second photoresist layers 3, 6 may be removed to expose end portions of the nano material strands 5 extending in the grooves 4 of the first photoresist layer 3 through the recesses 7.

In one embodiment, the recesses 7 may be patterned, for example, to have a square pillar shape or cylinder shape. Although only three recesses 7 are depicted in FIG. 7, it should be noted that there may be more or less than three recesses.

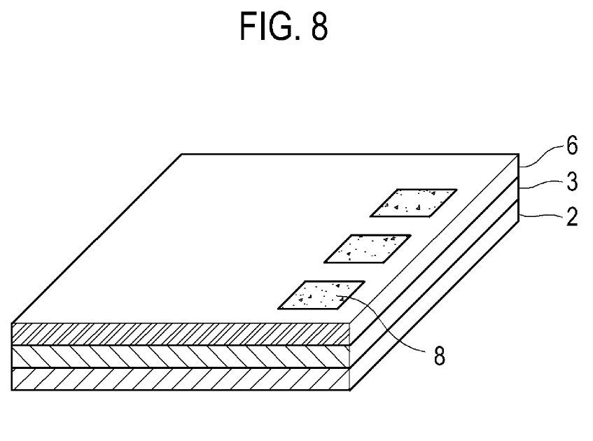

Thereafter, as shown in FIG. 8, a conductive material may be filled into the recesses 7 to physically and electrically contact and enclose the exposed end portions of the nano material strands 5 so as to provide conductive electrodes 8. As a result, the nano material strands 5 may make electrical contact with the conductive electrodes 8. In one embodiment, the conductive material may include, for example, but is not limited to, Ag, Cu, Al, etc.

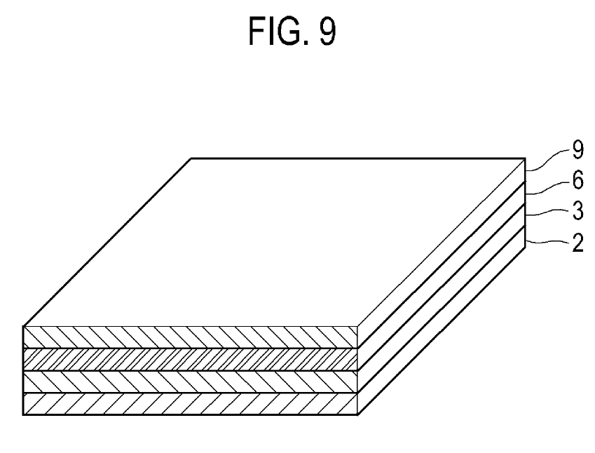

As shown in FIG. 9, a third photoresist layer 9 may be deposited on top of the conductive electrodes 8 and the remaining second photoresist layer 6. Further, the materials selected for the third photoresist layer 3 and the detailed deposition process may be similar to those of the first photoresist layer 3 in FIG. 3. Alternatively, the third photoresist layer 9 may be fabricated from different materials and a different deposition process may be employed.

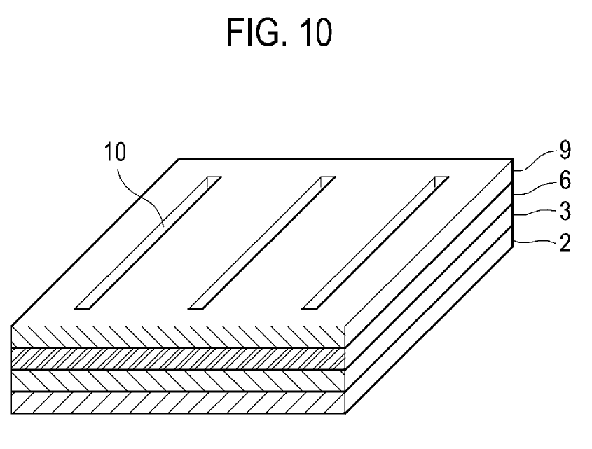

Referring to FIG. 10, the third photoresist layer 9 may be patterned by photolithography or other equivalent processes to define one or more grooves 10. The longitudinal length of each groove 10 may be much greater than the width in the lateral direction. The grooves 10 may form a transverse relationship with the grooves 4 defined in the first photoresist layer 3. As shown in FIG. 10, the grooves 10 may be substantially parallel to each other. Further, the grooves 10 may be equally spaced apart from adjacent ones. However, it should be noted that the present disclosure is not limited to such an arrangement. According to one embodiment, the grooves formed in the third photoresist layer 9 may be unequally or irregularly spaced apart from each other. Further, the patterning process for the third photoresist layer 6 may be similar to the process of patterning the first photoresist layer 3. Thus, detailed explanations regarding the patterning process are omitted herein.

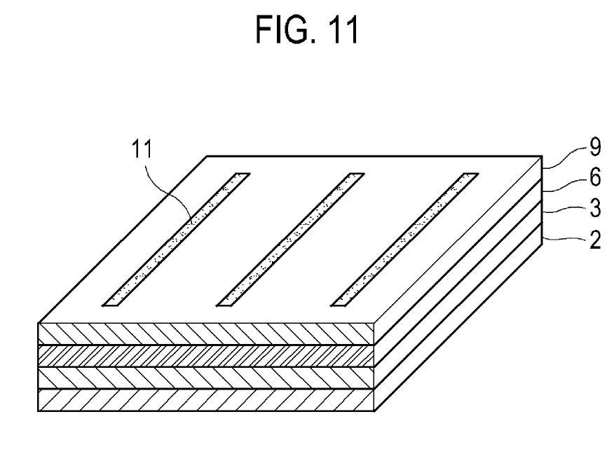

As shown in FIG. 11, the nano materials may then be deposited into the grooves 10 to define nano material strands 11 matching the respective grooves 10. The nano material strands 11 may include, for example, but are not limited to, carbon nanotubes, carbon nanowires, other elongated nano materials and the like. It should be noted that the selected nano materials for the strands 11 may or may not be the same as the nano materials for the strands 5. Further, the detailed process of forming the nano material strands 11 may be similar to that of the nano material strands 5. Thus, detailed explanations thereof are omitted herein.

Thereafter, a fourth photoresist layer 12 may be deposited onto the third photoresist layer 9 so as to entirely cover the grooves 10 having the nano material strands 11 disposed therein. The fourth photoresist layers 12 may be fabricated from the same material as the third photoresist layer 9. Alternatively, the fourth photoresist layer 12 may be made from different materials as long as it can be removed together with the third photoresist layer 9 in one patterning stage. The process of depositing the fourth photoresist layer 12 may be similar to the process of depositing the third photoresist layer 9.

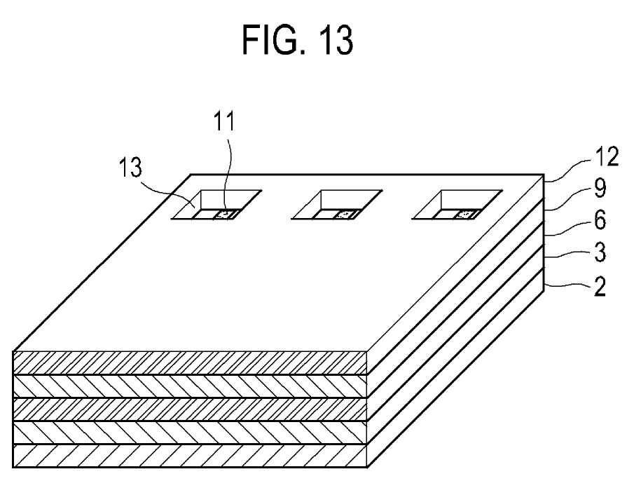

Thereafter, as shown in FIG. 13, the first, second, third and fourth photoresist layers 3, 6, 9, 12 may be patterned by photolithography or other equivalent processes to define the same number of recesses 13 as the grooves 10 passing through all the photoresist layers 3, 6 9, 12. As shown in FIG. 13, the recesses 13 may be arranged in a line near the edge 24 of the substrate 2. The recesses 13 may be equally spaced apart from each other, although they are not limited to such an arrangement. Further, photolithography or other equivalent processes may be performed sufficiently deep enough to remove a desired portion of the photoresist layers 3, 6, 9, 12. In one embodiment, the photoresist layers 3, 6, 9, 12 may be patterned away to expose the substrate 2 through the recesses 7. The photo resist layers 3, 6, 9, 12 may be removed to expose end portions of the nano material strands 11 extending in the grooves 10 of the third photoresist layer 3 through the recesses 7.

In one embodiment, the recesses 13 may be patterned, for example, to have a square pillar shape or cylinder shape. Although only three recesses 13 are depicted in FIG. 13, it should be noted that there may be more or less than three recesses.

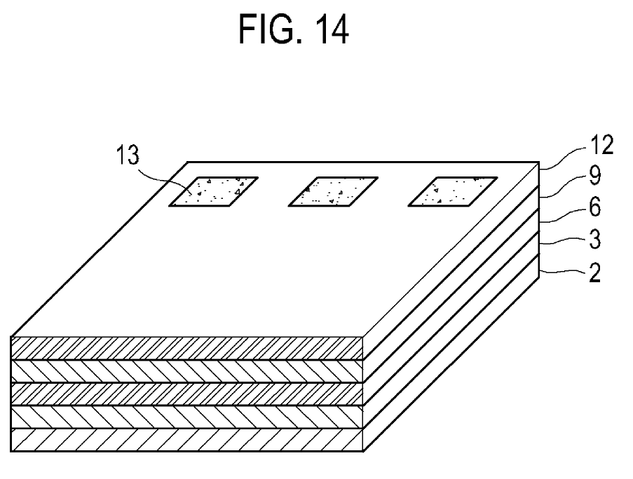

Referring to FIG. 14, a conductive material may then be filled into the recesses 13 to physically and electrically contact and enclose the exposed end portions of the nano material strands 11 so as to provide conductive electrodes 14. Thus, the nano material strands 11 may electrically contact the conductive electrodes 14. In one embodiment, the conductive material may include, for example, but is not limited to, Ag, Cu, Al, etc.

Thereafter, the remaining photoresist layers 3, 6, 9, 12 may be completely removed by an appropriate etching process or equivalents thereof As a result, as shown in FIG. 1, an array structure 100 of nano materials may remain on the substrate 2 including the nano material strands 11 protruding from one of the conductive electrodes 14 or the nano material strands 5 protruding from the conductive electrodes 8.

In one embodiment, the nano material strands 5 and the nano material strands 11 may be trimmed so as to have a substantially identical length. For the trimming process, a conventional ion beam milling process, which burns the end portions of the nano material strands 5, 11 exceeding a preset length, may be selected. However, it should be noted herein that other processes known in the art may be used instead.

In the embodiment shown in FIGS. 1 to 14, the array structure 100 may include two layers including the nano material strands 5, 11, each of which has an end coupled to the respective conductive electrode 8, 14. However, in another embodiment, the array structure of nano materials may include three or more layers including nano material strands connected to conductive electrodes as long as each conductive electrode and nano material strand are electrically isolated from others.

The series of steps (i.e., depositing and patterning a photoresist layer to form grooves, filling the grooves with nano material, depositing and patterning another photoresist layer to form recesses, and filling the recesses with a conductive material) may be repeated two or more times according to the number of nano strand layers included in the array structure of nano materials.

Further, it should be noted that any processing method, which is well known to or can be newly developed by those skilled in the art, may be selected for the above deposition, patterning and lithography processes. It should be also noted that any materials, which are well known to or can be newly developed by those skilled in the art, may be selected as the nano materials or conductive materials.

The parallel, crossed or transverse array structure of nano materials may be used as electronic, magnetic or optical components or as parts of more complicated electronic or optical devices. Especially, the above nano material cluster structures may be highly useful in the field of display. According to the present disclosure, various array structures of nano materials may be provided and used for various universal electronic, magnetic or optical devices.

In light of the present disclosure, those skilled in the art will appreciate that the methods described herein may be implemented in hardware, software, firmware, middleware or combinations thereof and utilized in systems, subsystems, components or sub-components thereof For example, a method implemented in software may include computer code to perform the operations of the method. This computer code may be stored in a machine-readable medium, such as a processor-readable medium or a computer program product, or transmitted as a computer data signal embodied in a carrier wave, or a signal modulated by a carrier, over a transmission medium or communication link. The machine-readable medium or processor-readable medium may include any medium capable of storing or transferring information in a form readable and executable by a machine (e.g., a processor, computer, etc.).

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An array structure of nano materials, comprising:
a substrate;
a first set of conductive electrodes disposed on the substrate;
a second set of conductive electrodes disposed on the substrate;
a plurality of first nano material strands protruding from the first conductive electrodes along at least a substantially similar first direction and in a first elevation from the substrate; and
a plurality of second nano material strands protruding from the second conductive electrodes along at least a substantially similar second direction and in a second elevation from the substrate, wherein the second elevation differs from the first elevation by at most several hundreds of nanometers,
wherein the first and second nano materials are configured to interact with each other when disposed adjacent to a target.

2. The array structure of nano materials of claim 1, wherein at least parts of the first and second nano materials cross each other in different elevations in any one of an acute angle, a right angle and an obtuse angle.

3. The array structure of nano materials of claim 1, wherein at least parts of the first and second nano materials extend in a coplanar relationship.

4. The array structure of nano materials of claim 3, wherein the coplanar relationship includes at least one of a direction of at least one of the nano materials, a length of at least one of the nano materials protruding from the electrodes and an arrangement between at least two of the nano materials.

5. A array structure of nano materials, comprising:
a first set of conductive electrodes;
a second set of conductive electrodes;
a plurality of first nano material strands protruding from the first conductive electrodes, wherein the first nano material strands are disposed in a coplanar relationship on a first plane; and
a plurality of second nano material strands protruding from the second conductive electrodes, wherein the second nano material strands are disposed in a coplanar relationship on a second plane substantially parallel with the first plane,
wherein at least a part of the second nano material strands extends in a transverse relationship with respect to at least a part of the first nano material strands.

6. The array structure of nano materials of claim 5, wherein the first conductive electrodes are equally spaced apart from each other.

7. The array structure of nano materials of claim 5, wherein the second conductive electrodes are equally spaced apart from each other.

8. The array structure of nano materials of claim 5, wherein a shape of the first conductive electrodes is any one of a square pillar and a cylinder.

9. The array structure of nano materials of claim 5, wherein a shape of the second conductive electrodes is any one of a square pillar and a cylinder.

10. The array structure of nano materials of claim 5, wherein the second conductive electrodes are taller than the first conductive electrodes.

11. The array structure of nano materials of claim 5, wherein the first and second nano material strands include any one of carbon nanotubes and carbon nanowires.

12. The array structure of nano materials of claim 5, wherein the first and second conductive electrodes form a shape L having a corner, and wherein one of the second conductive electrodes is located at the corner of the shape L.

13. The array structure of nano materials of claim 12, wherein the first nano material strands protruding from the first conductive electrode located at the corner of the shape L extend in a transverse relationship with respect to the second conductive electrodes.

14. An array structure of nano materials, comprising:
a substrate;
a first array of first nano material strands extending along a first direction and being directly/indirectly supported by the substrate;
a second array of second nano material strands extending along a second direction and being directly/indirectly supported by the substrate;
at least one first conductive electrode electrically contacting the first nano material strands and being mechanically coupled with the substrate; and
at least one second conductive electrode electrically contacting the second nano material strands and being mechanically coupled with the substrate,
wherein the first and second strands are disposed in a preset arrangement and spaced apart from each other by at most several hundreds of nanometers so that the first and second strands are configured to interact with each other when disposed adjacent to a target.

15. The array structure of nano materials of claim 14, wherein the first and second strands are disposed in a same elevation with respect to the substrate.

16. The array structure of nano materials of claim 15, wherein the first and second strands are disposed in different elevations with respect to the substrate.

17. The array structure of nano materials of claim 16, wherein at least some of the first strands and at least some of the second strands are disposed in any one of a parallel, normal and transverse relationship with respect to each other.

18. A method of preparing an array structure of nano materials, comprising the steps of:
providing a first layered structure having multiple layers on a substrate, the first layered structure including a layer having first nano material strands therein;
patterning the first layered structure to define first multiple recesses such that end portions of the first nano material strands and a part of the substrate in registration with the end portions are exposed through the first multiple recesses;
filling the first multiple recesses with a conductive material to form an intermediate structure;
providing a second layered structure having multiple layers on the intermediate structure, the second layered structure including a layer having second nano material strands therein;
patterning the second layered structure to define second multiple recesses such that end portions of the second nano material strands and a part of the substrate in registration with the end portions are exposed through the second multiple recesses; and
filling the second multiple recesses with a conductive material.

19. The method according to claim 18, wherein the substrate includes a transparent material.

20. The method according to claim 18, wherein the first nano material strands are disposed in parallel and substantially equally spaced apart from each other.

21. The method according to claim 18, wherein the second nano material strands are disposed in parallel and substantially equally spaced apart from each other.

22. The method according to claim 18, wherein the first and second nano materials include any one of carbon nanotubes and carbon nanowires.

23. The method according to claim 18, wherein the second nano material strands are perpendicular to an extending direction of the first nano material strands.

24. The method according to claim 18, further comprising the step of trimming the first nano material strands to have a substantially equal length.

25. The method according to claim 18, further comprising the step of trimming the second nano material strands to have a substantially equal length.

26. The method according to claim 18, wherein a shape of the first multiple recesses is any one of a square pillar and a cylinder.

27. The method according to claim 18, wherein a shape of the second multiple recesses is any one of a square pillar and a cylinder.

28. The method according to claim 18, wherein the first multiple recesses and the second multiple recesses are arranged to form a shape L having a corner, and wherein one of the second recesses is located at the corner of the shape L.

29. The method according to claim 27, wherein one of the second nano material strands extends in a transverse relationship with respect to the first recesses, and wherein the remaining second nano material strands extend in a transverse relationship with at least a part of the first nano material strands.

30. The method according to claim 18, wherein the step of providing the first layered structure comprises:
depositing a first photoresist layer on the substrate;
patterning the first photoresist layer to define first multiple grooves;
filling the first multiple grooves with nano materials so that the first nano material strands match the respective grooves; and
depositing a second photoresist layer to cover the first photoresist layer having the first nano material strands therein.

31. The method according to claim 30, wherein the step of providing the second layered structure comprises:
depositing a third photoresist layer on the intermediate structure;
patterning the third photoresist layer to define second multiple grooves;
filling the second grooves with nano materials so that the second nano material strands match the respective grooves; and
depositing a fourth photoresist layer to cover the third photoresist layer having the second nano material strands therein.

32. The method according to claim 3 1, further comprising the step of removing the first, second, third and fourth photoresist layers after filling the second multiple recesses with the conductive material.

33. The method according to claim 30, wherein a thickness of the first nano material strands is less than a depth of the first multiple grooves.

34. The method according to claim 31, wherein a thickness of the second nano material strands is less than a depth of the second multiple grooves.
